(19) United States
(12) Patent Application Publication
(10) Pub. No.: US 2024/0411605 A1
(43) Pub. Date: Dec. 12, 2024

(54) METHOD AND SYSTEM FOR PROCESSING COMPUTING TASK

(71) Applicant: Alibaba Innovation Private Limited, Singapore (SG)

(72) Inventors: Liang ZHAO, Zhejiang (CN); KuoLing HUANG, Pleasanton, CA (US); Wotao YIN, San Diego, CA (US)

(21) Appl. No.: 18/806,794

(22) Filed: Aug. 16, 2024

Related U.S. Application Data
(63) Continuation of application No. PCT/CN2023/076325, filed on Feb. 16, 2023.

(30) Foreign Application Priority Data
Feb. 21, 2022 (CN) 202210158681.9

(51) Int. Cl. G06F 9/50

(52) U.S. Cl. CPC G06F 9/5027

(57) ABSTRACT

A method for processing a computing task includes acquiring a target computing task used for solving a target problem; identifying the target computing task to determine problem structure information of the target problem; determining a processing mode of the target computing task based on the problem structure information; and acquiring a computed result of the target computing task according to the processing mode.

### CROSS-REFERENCE TO RELATED APPLICATIONS

The disclosure claims the benefits of priority to PCT Application No. PCT/CN2023/076325, filed Feb. 16, 2023, which claims the benefits of priority to Chinese Patent Application No. 202210158681.9, filed Feb. 21, 2022, both of which are incorporated by reference in their entireties.

### TECHNICAL FIELD

The present disclosure relates to the field of the computer technology, specifically to a method and system for processing a computing task.

### BACKGROUND

A solver is software for solving a numerical computing task and is widely used in technical fields such as cloud computing, finance, transportation, manufacturing, and energy. In the prior art, the solver may select a processing mode of local solving or remote solving during running.

For a solver performing local solving, the advantage is that the solver performs solving directly on a local device without the need for data transmission. The defect is that the performance of the local device is limited, which may lead to relatively slow solving of large-scale and difficult problems.

For a solver performing solving on a remote server, by means of a client and server architecture, a model file and a parameter file are sent to the remote server, and then, a computed result returned from the remote server is received. The advantage is that the remote computing server has good performance and strong computing capability. The defect is that for simple problems that are easy to solve, the data transmission process may result in a longer total time of remote solving than local solving.

Therefore, how to integrate the advantages of local solving and remote solving to improve the flexibility of the solving process of the solver has become one of the important issues in the art. For the above problem, no effective solution has been proposed yet.

### SUMMARY OF THE DISCLOSURE

Embodiments of the present disclosure provide a method for processing a computing task includes acquiring a target computing task used for solving a target problem; identifying the target computing task to determine problem structure information of the target problem; determining a processing mode of the target computing task based on the problem structure information; and acquiring a computed result of the target computing task according to the processing mode.

Embodiments of the present disclosure provide a system for processing a computing task. The system includes: a memory configured to store instructions; and one or more processors configured to execute the instructions to cause the system to perform operations including: acquiring a target computing task used for solving a target problem; identifying the target computing task to determine problem structure information of the target problem; determining a processing mode of the target computing task based on the problem structure information; and acquiring a computed result of the target computing task according to the processing mode.

Embodiments of the present disclosure provide a non-transitory computer readable medium that stores a set of instructions that is executable by one or more processors of an apparatus to cause the apparatus to perform operations including: acquiring a target computing task used for solving a target problem; identifying the target computing task to determine problem structure information of the target problem; determining a processing mode of the target computing task based on the problem structure information; and acquiring a computed result of the target computing task according to the processing mode.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 shows a block diagram of hardware structures of a computer terminal (or a mobile device) for implementing a method for processing a computing task.

FIG. 2 is a flowchart of an exemplary method for processing a computing task, according to some embodiments of the present disclosure.

FIG. 3 is a schematic diagram of an exemplary optional process for processing a computing task, according to some embodiments of the present disclosure.

FIG. 4 is a flowchart of another exemplary method for processing a computing task, according to some embodiments of the present disclosure.

FIG. 5 is a flowchart of still another exemplary method for processing a computing task, according to some embodiments of the present disclosure.

FIG. 6 is a schematic structural diagram of an exemplary apparatus for processing a computing task, according to some embodiments of the present disclosure.

FIG. 7 is a schematic structural diagram of another exemplary apparatus for processing a computing task according to an embodiment of the present invention.

FIG. 8 is a schematic structural diagram of still another exemplary apparatus for processing a computing task, according to some embodiments of the present disclosure.

FIG. 9 is a schematic structural diagram of yet another exemplary apparatus for processing a computing task, according to some embodiments of the present disclosure.

FIG. 10 is a structural block diagram of another exemplary computer terminal, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms or definitions incorporated by reference.

According to some embodiments of the present disclosure, a method for processing a computing task is provided. It is to be noted that the steps shown in the flowchart of the accompanying drawing may be executed in a computer system such as a set of computer executable instructions. Moreover, although a logical order is shown in the flowchart, in some cases, the steps shown or described may be executed in an order different from the order here.

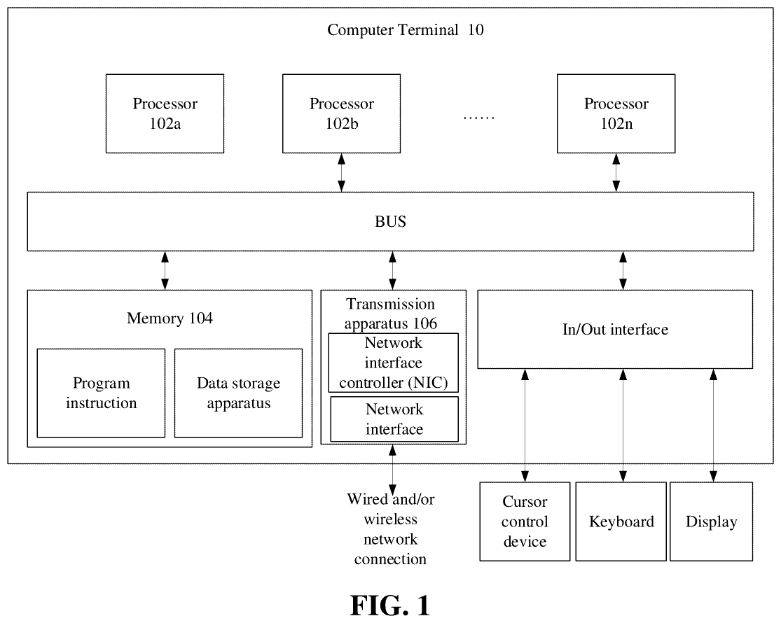

The method provided by the embodiments of the present disclosure may be executed in a mobile terminal, a computer terminal, or a similar arithmetic apparatus. FIG. 1 shows a block diagram of hardware structures of a computer terminal 10 (or a mobile device) for implementing a method for processing a computing task. As shown in FIG. 1, a computer terminal 10 (or a mobile device 10) may include one or a plurality of processors 102 (shown as 102a, 102b, . . . , 102n in the figure, and the processor 102 may include, but is not limited to, processing apparatuses such as a microcontroller unit (MCU) or a field programmable gate array (FPGA), a memory 104 for storing data, and a transmission apparatus 106 with a communication function. In addition, the computer terminal 10 (or the mobile device 10) may further include a display, an input/output interface (I/O interface), a universal serial bus (USB) port (which may be included as one of the ports of a BUS), a network interface, a power supply, or a camera. Those of ordinary skill in the art can understand that the structure shown in FIG. 1 is only schematic, and does not limit the structure of the above electronic apparatus. For example, the computer terminal 10 may further include more or less components than those shown in FIG. 1, or has configurations different from those shown in FIG. 1.

It is to be noted that one or a plurality of processors 102 or other data processing circuits mentioned above may be usually referred to as a “data processing circuit” herein. The data processing circuit may be completely or partially embodied as software, hardware, firmware or any other combination. In addition, the data processing circuit may be a single independent processing module, or may be completely or partially combined into any one of the other elements in the computer terminal 10 (or the mobile device). As involved in the embodiments of the present disclosure, the data processing circuit serves as a processor control (such as selection of a variable resistance terminal path connected with an interface).

The memory 104 can be configured to store software programs and modules of application software, such as program instructions/data storage apparatuses corresponding to the method for processing a computing task in the embodiments of the present disclosure. The processor 102 executes various functional applications and data processing by running the software programs and modules stored in the memory 104, thereby implementing the above method for processing a computing task. The memory 104 may include a high-speed random access memory and may also include a non-volatile memory, such as one or a plurality of magnetic storage apparatuses, flash memories or other non-volatile solid-state memories. In some examples, the memory 104 may further include memories remotely arranged relative to the processor 102, and the remote memories may be connected to the computer terminal 10 through a network. The examples of the above network include but are not limited to the Internet, Intranet, local area networks, mobile communication networks, and combinations thereof.

The transmission apparatus 106 is configured to receive or send data through a network. A specific example of the above network may include a wireless network provided by a communication supplier of the computer terminal 10. In an example, the transmission apparatus 106 includes a network interface controller (NIC), and the NIC can be connected with other network devices through a base station so as to communicate with the Internet. In an example, the transmission apparatus 106 may be a radio frequency (RF) module and is configured to communicate with the Internet in a wireless mode.

The display may be a touch screen type liquid crystal display (LCD). The LCD can enable a user to interact with a user interface of the computer terminal 10 (or the mobile device).

It is to be noted that in some embodiments, the computer device (or the mobile device) shown in FIG. 1 may include a hardware element (including a circuit), a software element (including computer codes stored on a computer-readable medium), or a combination of the hardware element and the software element. It is to be pointed out that FIG. 1 is only one example of a specific example and aims at showing the types of components which can exist in the above computer device (or the mobile device).

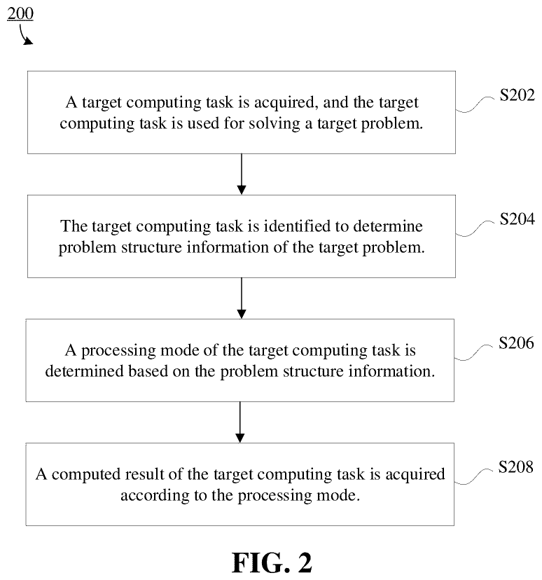

Under the above operating environment, the present disclosure provides a method for processing a computing task as shown in FIG. 2. FIG. 2 is a flowchart of an exemplary method 200 for processing a computing task, according to some embodiments of the present disclosure. As shown in FIG. 2, the method 200 for processing a computing task includes steps S202 to S208.

At step S202, a target computing task is acquired, and the target computing task is used for solving a target problem.

At step S204, the target computing task is identified to determine problem structure information of the target problem.

At step S206, a processing mode of the target computing task is determined based on the problem structure information.

At step S208, a computed result of the target computing task is acquired according to the processing mode.

In this embodiment of the present disclosure, the target computing task may be a numerical computing task in technical fields such as cloud computing, finance, transportation, manufacturing, and energy. The target computing task can be used for solving a target problem. The target problem may be a numerical problem in technical fields such as cloud computing, finance, transportation, manufacturing, and energy. The problem structure information of the target problem can be determined by identifying the target computing task. The more difficult the target computing task is and the more complex the problem structure information of the target problem is, the greater the amount of computing resources to be used by the computing task.

In some embodiments, the processing mode of the above target computing task may be local solving, remote solving or simultaneous local and remote solving. The processing mode of the target computing task can be determined based on the problem structure information of the above target problem. Thus, a computed result of the target computing task can be acquired according to the processing mode.

In this embodiment of the present disclosure, first, a target computing task is acquired, where the target computing task is used for solving a target problem; problem structure information of the target problem is determined by identifying the target computing task; a method of determining a processing mode of the target computing task based on the problem structure information is used; and a computed result of the target computing task is acquired according to the processing mode.

It is easy to notice that through this embodiment of the present disclosure, the target computing task is identified, and the problem structure information of the target problem is acquired, thereby determining the processing mode of the target computing task. The processing mode may be local solving, remote solving or simultaneous solving. As a result, the purpose of enabling a solver to automatically select a processing mode according to the problem structure information of the target problem is achieved to realize the technical effects of integrating the advantages of local solving and remote solving and improving the flexibility of the solving process of the solver, thereby solving the technical problem in the prior art that a method of fixing a processing mode of a solver to local solving or remote solving is poor in flexibility of a

In some embodiments, in step S204, the process of identifying the target computing task to determine the problem structure information of the target problem includes the following steps S241 to S243.

At step S241, the target computing task is identified to determine a target optimization model corresponding to the target computing task, where the target optimization model is used for modeling the target computing task into a target form to be solved.

At step S242, feature information of the target optimization model is acquired, where the feature information is used for representing the computing content corresponding to the target computing task.

At step S243, the problem structure information is determined based on the feature information.

In the above embodiment, the target computing task may be a numerical computing task in technical fields such as cloud computing, finance, transportation, manufacturing and energy. The above target optimization model corresponding to the target computing task can be determined by identifying the target computing task. The target optimization model can be used for modeling the target computing task into a target form to be solved.

For example, the above target computing task may be a mathematical programming problem Q1. The above target optimization model may be an application programming interface (API) for modeling, denoted as API01. Through the API01, the mathematical programming problem Q1 can be modeled into a form that can be understood by a program of a solver S1 (equivalent to the above target form). Solver S1 could be an optimization solver which is a numerical computing software for solving optimization problems.

In the above embodiment, the feature information of the above target optimization model is acquired. The feature information can be used for representing the computing content corresponding to the above target computing task, and may include but is not limited to the number of variables, the number of constraints, the number of non-zero elements, etc. The problem structure information of the target problem can be determined based on the feature information.

For example, for the mathematical programming problem Q1, the feature information of the corresponding target optimization model API01 includes the number N1 of variables, the number N2 of constraints, and the number N3 of non-zero elements. The number N1 of variables is used for representing the number of variables involved in the computing process of the mathematical programming problem Q1. The number N2 of constraints is used for representing the number of constraint conditions involved in the computing process of the mathematical programming problem Q1. The number N3 of non-zero elements is used for representing the complexity of the data determinant involved in the computing process of the mathematical programming problem Q1. Problem structure information A1 corresponding to the mathematical programming problem Q1 can be computed by a preset relational expression based on the number N1 of variables, the number N2 of constraints and the number N3 of non-zero elements.

In some embodiments, in step S206, the process of determining the processing mode of the target computing task based on the problem structure information includes the following steps S261 to S264.

At step S261, the amount of computing resources of the target computing task is determined based on the problem structure information.

At step S262, it is determined that the processing mode of the target computing task is a local processing mode when the amount of computing resources meets a first preset condition.

At step S263, it is determined that the processing mode of the target computing task is a remote processing mode when the amount of computing resources meets a second preset condition.

At step S264, it is determined that the processing mode of the target computing task is simultaneous use of the local processing mode and the remote processing mode when the amount of computing resources meets a third preset condition.

In the above embodiment, the target computing task may be a numerical computing task in technical fields such as cloud computing, finance, transportation, manufacturing and energy. The target computing task can be used for solving a target problem. The target problem may be a numerical problem in technical fields such as cloud computing, finance, transportation, manufacturing and energy. The amount of computing resources of the above target computing task can be determined based on the problem structure information of the above target problem. The more difficult the target computing task is and the more complex the problem structure information of the target problem is, the greater the amount of computing resources to be used by the computing task.

In the above embodiment, the first preset condition may be that the amount of computing resources of the target computing task is lower than a lower preset threshold, e.g., a first preset threshold. When the amount of computing resources meets the first preset condition, it indicates that there are less resources required for executing the target computing task, and thus, the processing mode of the target computing task can be set to the local processing mode. The local processing mode can use a corresponding solver on a local device to solve the computing content corresponding to the target computing task.

In the above embodiment, the second preset condition may be that the amount of computing resources of the target computing task is higher than a higher preset threshold, e.g., a second preset threshold, the second preset threshold is greater than the first preset threshold. When the amount of computing resources meets the second preset condition, it indicates that there are more resources required for executing the target computing task, and thus, the processing mode of the target computing task can be set to the remote processing mode. The remote processing mode can use a corresponding solver on a remote server to solve the computing content corresponding to the target computing task.

In the above embodiment, the third preset condition may be that the amount of computing resources of the target computing task does not meet the first preset condition or the second preset condition. When the third preset condition is met, it indicates that it is difficult to determine the amount of resources required for executing the target computing task. Thus, the processing mode of the target computing task can be set to simultaneous use of the local processing mode and the remote processing mode.

It is to be noted that in actual application scenarios in technical fields such as cloud computing, finance, transportation, manufacturing and energy, the computing performance of the local device is usually lower than the computing performance of the remote server. Therefore, computing tasks that require few resources are more suitable for computing on the local device to save the data transmission time, and computing tasks that require more resources are more suitable for computing on the remote server to save the solving computation time. In particular, the computing task, the required resources of which cannot be determined, can perform the computation simultaneously on the local device and the remote server, and then, the firstly obtained computed result is acquired to save the time.

In some embodiment, the method for processing a computing task further includes the following steps S210 and S212.

At step S210, the current network connection status information is acquired, where the network connection status information is used for determining whether the current network connection is abnormal.

At step S212, switching is performed between multiple processing modes based on the network connection status information. The multiple processing modes include: the local processing mode, the remote processing mode, and simultaneous use of the local processing mode and the remote processing mode.

In the above embodiment, the current network connection status information can be used for determining whether the current network connection of the current device is abnormal. The network connection status may be that the remote network is connected, the remote network is not connected, etc. Switching is performed between multiple processing modes can be in the process for processing a computing task according to the network connection status information.

In some embodiments, the multiple processing modes may include: a local processing mode which can use a corresponding solver on a local device to solve the computing content corresponding to the target computing task; a remote processing mode which can use a corresponding solver on a remote server to solve the computing content corresponding to the target computing task; and simultaneous use of the local processing mode and the remote processing mode.

In some embodiments, the method for processing a computing task further includes the following step S214.

At step S214, when the local processing mode and the remote processing mode are simultaneously used and the computed result is acquired in any one of the local processing mode and the remote processing mode, the other one of the local processing mode and the remote processing mode is ended.

In the above embodiment, when the amount of computing resources of the target computing task meets the third preset condition, it indicates that it is difficult to determine the amount of resources required for executing the target computing task. In this case, the following racing mechanism can be used: the local processing mode and the remote processing mode are simultaneously used; and when the computed result is acquired in any one of the local processing mode and the remote processing mode, the computed result is directly acquired, and the other one of the local processing mode and the remote processing mode is ended.

For example, when it is difficult to determine the amount of resources required for executing the mathematical programming problem Q1, the computation is performed for the mathematical programming problem Q1 on the local device and the remote server simultaneously. If the local device obtains the computed result first, the computed result is acquired, and the computation on the remote server is stopped; and if the remote server returns the computed result first, the computed result is acquired, and the computation on the local device is stopped.

In some embodiments, the method for processing a computing task further includes the following steps S216 and S218.

At step S216, whether the target computing task is set with parameter information corresponding to the remote processing mode is determined.

At step S218, it is determined that the processing mode includes the remote processing mode when the target computing task is set with the parameter information.

In the above embodiment, the target computing task may be a numerical computing task in technical fields such as cloud computing, finance, transportation, manufacturing, and energy. The target computing task may be set with multiple parameter information (such as processing mode information, processing time limit information and task type information).

In the above embodiment, before the corresponding processing mode of the target computing task is determined based on the problem structure information of the target problem, it is necessary to determine whether the target computing task is set with the parameter information corresponding to the remote processing mode. If the target computing task is set with the parameter information corresponding to the remote processing mode, the processing mode of the target computing task may be set to the local processing mode, the remote processing mode or simultaneous use of the local processing mode and the remote processing mode according to the problem structure information. If the target computing task is not set with the parameter information corresponding to the remote processing mode, the processing mode of the target computing task may be set to the local processing mode.

In some embodiments, the method for processing a computing task further includes the following steps S220 and S222.

At step S220, a solver corresponding to the processing mode and an optimization parameter corresponding to the solver are determined, where the optimization parameter is used for controlling the behavior of the solver.

At step S222, the optimization parameter is used for controlling the solver to acquire the computed result.

In the above embodiment, for the processing mode of the target computing task, the solver corresponding to the processing mode and the optimization parameter corresponding to the solver can be determined. The optimization parameter can be used for controlling the solver to acquire the computed result of the target computing task.

For example, if it is determined that the processing mode of a computing task Q2 is a local processing mode according to the problem structure information of a computing task Q2, a solver S2 for local processing, corresponding to the computing task Q2, can be determined, and an optimization parameter C2 corresponding to the solver can be determined. Then, the optimization parameter C2 can be used on a local device to control the solver S2 to acquire a computed result R2 of the computing task Q2.

For another example, if it is determined that the processing mode of a computing task Q3 is a remote processing mode according to the problem structure information of a computing task Q3, a solver R3 for remote processing, corresponding to the computing task Q3, can be determined, and an optimization parameter C3 corresponding to the solver can be determined. Then, the optimization parameter C3 can be used on a remote server to control the solver S3 to acquire a computed result R3 of the computing task Q3.

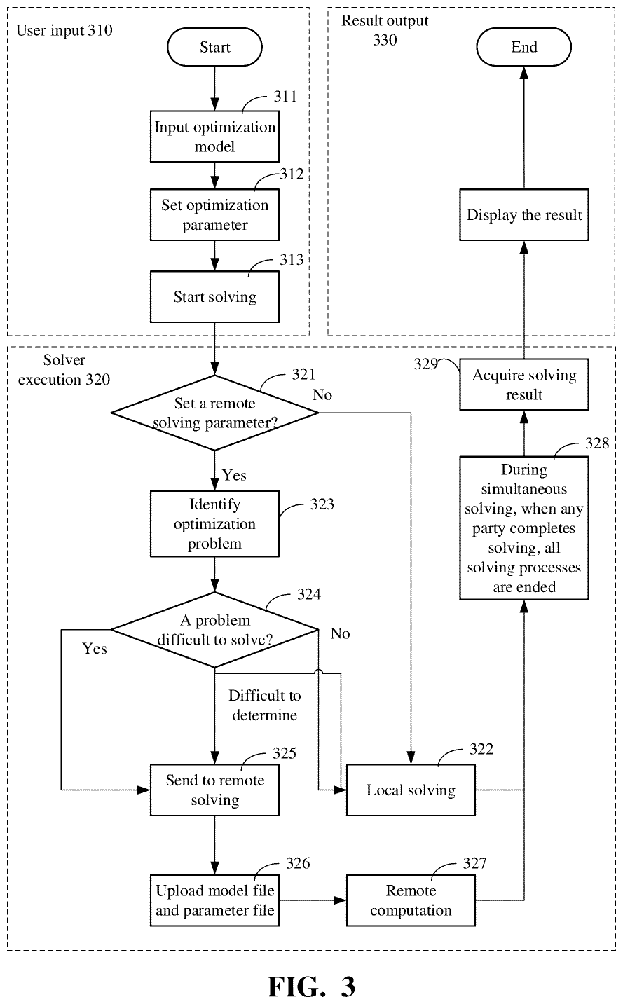

FIG. 3 is a schematic diagram of an optional exemplary process 300 for processing a computing task, according to some embodiments of the present disclosure. As shown in FIG. 3, the processing 300 for a computing task may include three parts: user input 310, solver execution 320, and result output 330. In particular, in the section of solver execution 320, automatic selection of the processing mode corresponding to the computing task is performed through two determinations: “whether to set a remote solving parameter 321” and “whether it is a problem difficult to solve 324”. A solving result output by a solver is displayed to a user through the section of result output 330.

Specifically, as shown in FIG. 3, in the section of user input 310, the user needs to perform the following operations: an optimization model is inputted 311, where the optimization model may be an API for modeling; and an optimization parameter is set 312, where the optimization parameter is used for controlling the behavior of the solver to optimize the solving process.

Specifically, as shown in FIG. 3, in the section of solver execution 320, “whether to set a remote solving parameter” 321 is determined first. For a computing task which is not set with a remote solving parameter, local solving 322 is performed directly. For a computing task which is set with a remote solving parameter, an optimization problem corresponding to the computing task is identified 324. The identification process 324 may include the following method step 1 to step 4.

At step 1, a computing task is acquired, an API for modeling, corresponding to the computing task, is determined from an optimization model inputted by a user;

At step 2, the API for modeling, corresponding to the computing task, is used for modeling the computing task into a form to be solved that can be identified by the solver;

At step 3, feature information of the API for modeling, corresponding to the computing task, is acquired; and

At step 4, the amount of computing resources of the computing task is determined based on the feature information.

The amount of computing resources of the computing task can be obtained through the above step 1 to step 4, and then it is determined whether the computing task is a problem difficult to solve 324. If the computing task is a problem difficult to solve, the computing task is sent to remote solving 325, a model file and a parameter file are uploaded 326 to a remote server, and then, the computation is performed on the remote server 327. If the computing task does not belong to a problem difficult to solve, computation is performed directly on a local device 322. If it is impossible to determine whether the computing task belongs to a problem difficult to solve, the computing task is simultaneously sent to the local device 322 and the remote server 325 for solving. In particular, during simultaneous solving, when any party completes solving, all solving processes are ended 328. The firstly acquired solving result is output to the user 329.

It is to be noted that the feature information for identifying the optimization problem may include but is not limited to the data size, the number of variables, the number of constraints, the number of non-zero elements, etc. The method provided in this embodiment can be used for a client and server architecture, for example, a SolveProblem API for local solving is embedded with an API for remote solving (including a submitTask API for submitting a problem and a retrieveTask API for acquiring a result), so that the API for local solving and the API for remote solving are unified to achieve automatic selection of the processing mode of the computing task. SolveProblem is an application programming interface (API) used by a solver to execute a local solving command. SubmitTask is an API used by a client to submit a computing operation during remote solving. RetrieveTask is an API used by a client to acquire a computed result from a remote computing server during remote solving.

Through the method provided in this embodiment, the API for local solving and the API for remote solving can be unified. The amount of computing resources to be used is acquired by identifying the target computing task, and the local processing mode, the remote processing mode, or the simultaneous local and remote processing mode is automatically determined based on the amount of computing resources to be used, thereby avoiding the problem that the user needs to perform manual selection when processing the computing task.

In some embodiments, a graphical user interface is provided by a terminal device, the content displayed in the graphical user interface at least partially includes a computing task solving scenario, and the method for processing a computing task further includes the following steps S302 to S308.

At step S302, a plurality of candidate optimization models are displayed in the graphical user interface.

At step S304, a target optimization model is determined from the plurality of candidate optimization models in response to a first control operation acting on the graphical user interface.

At step S306, an optimization parameter associated with the target optimization model is set in response to a second control operation acting on the target optimization model.

At step S308, the computed result is acquired based on the target optimization model and the optimization parameter in response to a third control operation acting on a target control, and the computed result is displayed in the graphical user interface.

In the above embodiment, a user can at least partially obtain the above computing task solving scenario through the content in the graphical user interface displayed through an electronic apparatus. The user can perform the first control operation, the second control operation and the third control operation in the computing task solving scenario. A plurality of candidate optimization models can be displayed in the above graphical user interface.

Specifically, in the above graphical user interface, the user can perform the first control operation on the graphical user interface, that is, the user can determine the target optimization model by controlling part of the plurality of candidate optimization models displayed in the graphical user interface.

Specifically, in the above graphical user interface, the user can perform the second control operation on the target optimization model, that is, the user can set the above optimization parameter of the target optimization model by controlling control buttons (such as a setting button, an association button, and the like) corresponding to the target optimization model. The optimization parameter can be used for controlling the solver to acquire the computed result of the target computing task.

Specifically, in the above graphical user interface, the user can perform the third control operation on the target control, that is, the user can acquire the above computed result based on the above target optimization model and the above optimization parameter by controlling trigger buttons (such as a computation starting button, a result acquiring button, and the like) corresponding to the computing process, and the computed result is displayed to the user through the graphical user interface.

In particular, the first control operation, the second control operation, and the third control operation may be touch operations. The touch operation refers to the user touching the display screen of the terminal device with a finger and controlling the terminal device. The touch operation may include single-point touch or multi-point touch. The touch operation of each touch point may include clicking, long-pressing, re-pressing, swiping, or the like. The first control operation, the second control operation and the third control operation may also be control operations implemented through input devices such as a mouse and a keyboard.

In some embodiment, the method for processing a computing task further includes the following steps S310 and S312.

At step S310, the parameter content of the optimization parameter is adjusted in response to a fourth control operation acting on the optimization parameter to obtain an adjusted result.

At step S312, the computed result is updated based on the adjusted result.

In the above embodiment, the user can also perform the fourth control operation on the optimization parameter in the graphical user interface, that is, the user can adjust the parameter content of the optimization parameter by controlling controls (such as an adjusting button, an adjusting control bar, and the like) related to the parameter content of the optimization parameter, thereby obtaining the adjusted result. The adjusted result can be used for updating the computed result.

In particular, the fourth control operation may be a touch operation. The touch operation refers to the user touching the display screen of the above terminal device with a finger and controlling the terminal device. The touch operation may include single-point touch or multi-point touch, where the touch operation of each touch point may include clicking, long-pressing, re-pressing, swiping, or the like. The fourth control operation may also be a control operation implemented through input devices such as a mouse and a keyboard.

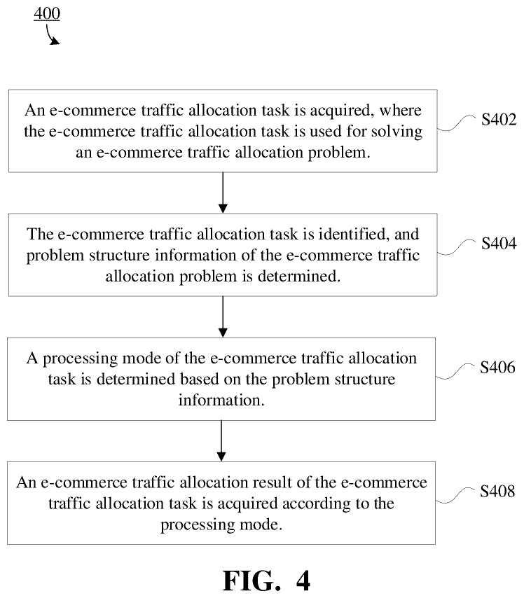

Under the above operating environment, the present disclosure provides a method for processing a computing task as shown in FIG. 4. FIG. 4 is a flowchart of another exemplary method 400 for processing a computing task, according to some embodiments of the present disclosure. As shown in FIG. 4, the method 400 for processing a computing task includes steps S402 to S408.

At step S402, an e-commerce traffic allocation task is acquired, where the e-commerce traffic allocation task is used for solving an e-commerce traffic allocation problem.

At step S404, the e-commerce traffic allocation task is identified to determine problem structure information of the e-commerce traffic allocation problem.

At step S406, a processing mode of the e-commerce traffic allocation task is determined based on the problem structure information.

At step S408, an e-commerce traffic allocation result of the e-commerce traffic allocation task is acquired according to the processing mode.

In this embodiment of the present disclosure, the e-commerce traffic allocation task is a computing task for allocating online passenger traffic in actual e-commerce application scenarios. The e-commerce traffic allocation task can be used for solving an e-commerce traffic allocation problem. The e-commerce traffic allocation problem may be a numerical problem related to online passenger traffic allocation in actual e-commerce application scenarios. The problem structure information of the e-commerce traffic allocation problem can be determined by identifying the e-commerce traffic allocation task. The more difficult the e-commerce traffic allocation task is and the more complex the problem structure information of the e-commerce traffic allocation problem is, the greater the amount of the corresponding computing resources to be used.

In some embodiments, the processing mode of the above e-commerce traffic allocation task may be local solving, remote solving, or simultaneous local and remote solving. The processing mode of the e-commerce traffic allocation task can be determined based on the problem structure information of the e-commerce traffic allocation problem. Thus, an e-commerce traffic allocation result of the e-commerce traffic allocation task can be acquired according to the processing mode.

In this embodiment of the present disclosure, first, an e-commerce traffic allocation task is acquired, where the e-commerce traffic allocation task is used for solving an e-commerce traffic allocation problem; problem structure information of the e-commerce traffic allocation problem is determined by identifying the e-commerce traffic allocation task; a method of determining a processing mode of the e-commerce traffic allocation task based on the problem structure information is used; and an e-commerce traffic allocation result of the e-commerce traffic allocation task is acquired according to the processing mode.

It is easy to notice that through this embodiment of the present disclosure, the e-commerce traffic allocation task is identified, and the problem structure information of the e-commerce traffic allocation problem is acquired, thereby determining the processing mode of the e-commerce traffic allocation task. The processing mode may be local solving, remote solving, or simultaneous solving. As a result, the purpose of enabling the solver to automatically select a processing mode according to the problem structure information of the e-commerce traffic allocation problem is achieved to realize the technical effects of integrating the advantages of local solving and remote solving and improving the flexibility of the solving process of the solver, thereby solving the technical problem that a method of fixing a processing mode of a solver to local solving or remote solving is poor in flexibility of a solving process.

In some embodiments, a graphical user interface is provided by a terminal device, the content displayed in the graphical user interface at least partially includes an e-commerce traffic allocation scenario, and the method for processing a computing task further includes the following steps S410 to S416.

At step S410, a plurality of candidate e-commerce traffic allocation models are displayed in the graphical user interface.

At step S412, a target e-commerce traffic allocation model is determined from the plurality of candidate e-commerce traffic allocation models in response to a first control operation acting on the graphical user interface.

At step S414, an e-commerce traffic allocation parameter associated with the target e-commerce traffic allocation model is set in response to a second control operation acting on the target e-commerce traffic allocation model.

At step S416, the e-commerce traffic allocation result is acquired based on the target e-commerce traffic allocation model and the e-commerce traffic allocation parameter in response to a third control operation acting on a target control, and the e-commerce traffic allocation result is displayed in the graphical user interface.

In the above embodiment, a user can at least partially obtain the above e-commerce traffic allocation scenario through the content in the graphical user interface displayed through an electronic apparatus. The user can perform the first control operation, the second control operation and the third control operation in the e-commerce traffic allocation scenario. A plurality of candidate e-commerce traffic allocation models can be displayed in the above graphical user interface.

Specifically, in the above graphical user interface, the user can perform the first control operation on the graphical user interface, that is, the user can determine the target e-commerce traffic allocation model by controlling part of the plurality of candidate e-commerce traffic allocation models displayed in the graphical user interface.

Specifically, in the above graphical user interface, the user can perform the second control operation on the target e-commerce traffic allocation model, that is, the user can set the above e-commerce traffic allocation parameter of the target e-commerce traffic allocation model by controlling control buttons (such as a parameter setting button, a parameter association button, and the like) corresponding to the target e-commerce traffic allocation model. The e-commerce traffic allocation parameter can be used for controlling the target e-commerce traffic allocation model to acquire the above e-commerce traffic allocation result.

Specifically, in the above graphical user interface, the user can perform the third control operation on the target control, that is, the user can acquire the above computed result based on the above target optimization model and the above optimization parameter by controlling trigger buttons (such as an allocation starting button, an allocation result acquiring button, and the like) corresponding to the e-commerce traffic allocation process, and the computed result is displayed to the user through the graphical user interface.

In particular, the first control operation, the second control operation and the third control operation may be touch operations. The touch operation refers to the user touching the display screen of the above terminal device with a finger and controlling the terminal device. The touch operation may include single-point touch or multi-point touch, where the touch operation of each touch point may include clicking, long-pressing, re-pressing, swiping, or the like. The first control operation, the second control operation and the third control operation may also be control operations implemented through input devices such as a mouse and a keyboard.

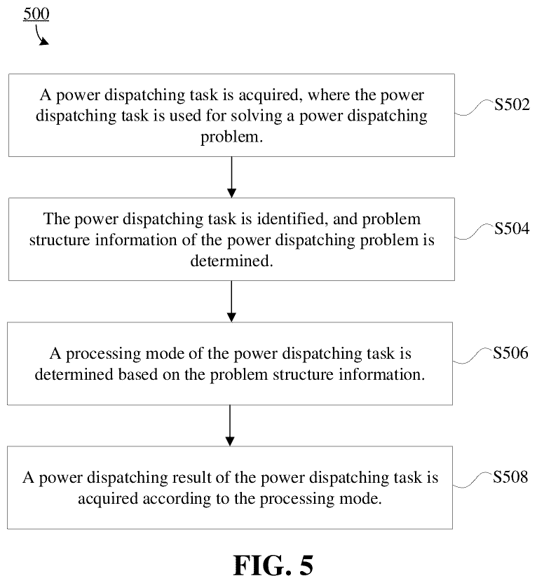

Under the above operating environment, the present disclosure provides a method for processing a computing task. FIG. 5 is a flowchart of still another exemplary method 500 for processing a computing task, according to some embodiments of the present disclosure. As shown in FIG. 5, the method 500 for processing a computing task includes steps S502 to S508.

At step S502, a power dispatching task is acquired, where the power dispatching task is used for solving a power dispatching problem.

At step S504, the power dispatching task is identified to determine problem structure information of the power dispatching problem.

At step S506, a processing mode of the power dispatching task is determined based on the problem structure information.

At step S508, a power dispatching result of the power dispatching task is acquired according to the processing mode.

In this embodiment of the present disclosure, the power dispatching task may be a computing task for dispatching power output or power stock in scenarios such as power production and power sales. The power dispatching task can be used for solving a power dispatching problem. The power dispatching problem may be a numerical problem related to dispatching of power output or power stock in scenarios such as power production and power sales. The problem structure information of the power dispatching problem can be determined by identifying the power dispatching task. The more difficult the power dispatching task is and the more complex the problem structure information of the power dispatching problem is, the greater the amount of the corresponding computing resources to be used.

In some embodiments, the processing mode of the above power dispatching task may be local solving, remote solving, or simultaneous local and remote solving. The processing mode of the power dispatching task can be determined based on the problem structure information of the power dispatching problem. Thus, a power dispatching result of the power dispatching task can be acquired according to the processing mode.

In this embodiment of the present disclosure, first, a power dispatching task is acquired, where the power dispatching task is used for solving a power dispatching problem; problem structure information of the power dispatching problem is determined by identifying the power dispatching task; a method of determining a processing mode of the power dispatching task based on the problem structure information is used; and a power dispatching result of the power dispatching task is acquired according to the processing mode.

It is easy to notice that through this embodiment of the present disclosure, the power dispatching task is identified and the problem structure information of the power dispatching problem is acquired, thereby determining the processing mode of the power dispatching task. The processing mode may be local solving, remote solving, or simultaneous solving. As a result, the purpose of enabling the solver to automatically select a processing mode according to the problem structure information of the power dispatching problem is achieved to realize the technical effects of integrating the advantages of local solving and remote solving and improving the flexibility of the solving process of the solver, thereby solving the technical problem in the prior art that a method of fixing a processing mode of a solver to local solving or remote solving is poor in flexibility of a solving process.

In some embodiments, in step S504, the process of identifying the power dispatching task and determining the problem structure information of the power dispatching problem includes the following method steps S541 to S543.

At step S541, the power dispatching task is identified to determine a target optimization model corresponding to the power dispatching task, where the target optimization model is used for modeling the power dispatching task into a target form to be solved;

At step S542, feature information of the target optimization model is acquired, where the feature information is used for representing the computing content corresponding to the power dispatching task.

At step S543, the problem structure information is determined based on the feature information.

In the above embodiment, the power dispatching task may be a computing task for dispatching power output or power stock in scenarios such as power production and power sales. The target optimization model corresponding to the power dispatching task can be determined by identifying the power dispatching task. The target optimization model can be used for modeling the power dispatching task into a target form to be solved.

For example, the above power dispatching task may be a mathematical programming problem Q21. The above target optimization model may be an API for modeling, denoted as API201. Through the API201, the mathematical programming problem Q21 can be modeled in a form that can be understood by a program of a solver S21 (equivalent to the above target form).

In the above embodiment, the feature information of the target optimization model is acquired. The feature information can be used for representing the computing content corresponding to the above power dispatching task, and may include but is not limited to the number of variables, the number of constraints, the number of non-zero elements, etc. The problem structure information of the power dispatching problem can be determined based on the feature information.

For example, the above power dispatching task may be the mathematical programming problem Q21, and the feature information of the corresponding target optimization model API201 includes the number N21 of variables, the number N22 of constraints, and the number N23 of non-zero elements, where the number N21 of variables is used for representing the number of variables involved in the computing process of the mathematical programming problem Q21; the number N22 of constraints is used for representing the number of constraint conditions involved in the computing process of the mathematical programming problem Q21; and the number N23 of non-zero elements is used for representing the complexity of the data determinant involved in the computing process of the mathematical programming problem Q21. Problem structure information A21 corresponding to the mathematical programming problem Q21 can be computed by a preset relational expression based on the number N21 of variables, the number N22 of constraints and the number N23 of non-zero elements.

In some embodiments, in step S506, the process of determining the processing mode of the power dispatching task based on the problem structure information includes the following steps S561 to S564.

At step S561, the amount of computing resources of the power dispatching task is determined based on the problem structure information.

At step S562, it is determined that the processing mode of the power dispatching task is a local processing mode when the amount of computing resources meets a first preset condition.

At step S563, it is determined that the processing mode of the power dispatching task is a remote processing mode when the amount of computing resources meets a second preset condition.

At step S564, it is determined that the processing mode of the power dispatching task is simultaneous use of the local processing mode and the remote processing mode when the amount of computing resources meets a third preset condition.

In the above embodiment, the power dispatching task is a computing task for dispatching power output or power stock in scenarios such as power production and power sales. The power dispatching task can be used for solving a power dispatching problem. The power dispatching problem may be a numerical problem related to dispatching of power output or power stock in scenarios such as power production and power sales. The amount of computing resources of the above power dispatching task can be determined based on the problem structure information of the power dispatching problem. The more difficult the power dispatching task is and the more complex the problem structure information of the power dispatching problem is, the greater the amount of the computing resources to be used by the power dispatching task.

In the above embodiment, the first preset condition may be that the amount of computing resources of the power dispatching task is lower than a lower preset threshold, e.g., a first preset threshold. When the amount of computing resources meets the first preset condition, it indicates that there are less resources required for executing the power dispatching task, and thus, the processing mode of the power dispatching task can be set to the local processing mode. The local processing mode can use a corresponding solver on a local device to solve the computing content corresponding to the power dispatching task.

In the above embodiment, the second preset condition may be that the amount of computing resources of the power dispatching task is higher than a higher preset threshold, e.g., a second preset threshold, and the second preset threshold is higher than the first preset threshold. When the amount of computing resources meets the second preset condition, it indicates that there are more resources required for executing the power dispatching task, and thus, the processing mode of the power dispatching task can be set to the remote processing mode. The remote processing mode can use a corresponding solver on a remote server to solve the computing content corresponding to the power dispatching task.

In the above embodiment, the third preset condition may be that the amount of computing resources of the power dispatching task does not meet the first preset condition or the second preset condition. When the third preset condition is met, it indicates that it is difficult to determine the amount of resources required for executing the power dispatching task. Thus, the processing mode of the power dispatching task can be set to simultaneous use of the local processing mode and the remote processing mode.

It is to be noted that in actual application scenarios of power dispatching, the computing performance of the local device is usually lower than the computing performance of the remote server. Therefore, computing tasks that require few resources are more suitable for computing on the local device to save the data transmission time, and computing tasks that require more resources are more suitable for computing on the remote server to save the solving computation time. In particular, the computing task, the required resources of which cannot be determined, can perform the computation simultaneously on the local device and the remote server, and then, the firstly obtained power dispatching result is acquired to save the time.

In some embodiments, the method for processing a computing task further includes the following steps S510 and S512.

At step S510, the current network connection status information is acquired, where the network connection status information is used for determining whether the current network connection is abnormal.

At step S512, switching is performed between multiple processing modes based on the network connection status information. The multiple processing modes include: a local processing mode, a remote processing mode, and simultaneous use of the local processing mode and the remote processing mode.

In the above embodiment, the current network connection status information can be used for determining whether the current network connection of the current device is abnormal. The network connection status may be that the remote network is connected, the remote network is not connected, etc. Switching is performed between multiple processing modes in the process for processing a power dispatching task according to the network connection status information.

In some embodiments, the above multiple processing modes may include: a local processing mode which can use a corresponding solver on a local device to solve the computing content corresponding to the power dispatching task; a remote processing mode which can use a corresponding solver on a remote server to solve the computing content corresponding to the power dispatching task; and simultaneous use of the local processing mode and the remote processing mode.

In some embodiments, the method for processing a computing task further includes the following step S514.

At step S514, when the local processing mode and the remote processing mode are simultaneously used and the power dispatching result is acquired in any one of the local processing mode and the remote processing mode, the other one of the local processing mode and the remote processing mode is ended.

In the above embodiment, when the amount of computing resources of the power dispatching task meets the third preset condition, it indicates that it is difficult to determine the amount of resources required for executing the power dispatching task. In this case, the following racing mechanism can be used: the local processing mode and the remote processing mode are simultaneously used; and when the power dispatching result is acquired in any one of the local processing mode and the remote processing mode, the power dispatching result is directly acquired, and the other one of the local processing mode and the remote processing mode is ended.

For example, when it is difficult to determine the amount of resources required for executing the mathematical programming problem Q21, the computation is performed for the mathematical programming problem Q21 on the local device and the remote server simultaneously. If the local device obtains the power dispatching result first, the power dispatching result is acquired, and the computation on the remote server is stopped; and if the remote server returns the power dispatching result first, the power dispatching result is acquired, and the computation on the local device is stopped.

In some embodiments, the method for processing a computing task further includes the following steps S516 and S518.

At step S516, whether the power dispatching task is set with parameter information corresponding to the remote processing mode is determined.

At step S518, it is determined that the processing mode includes the remote processing mode when the power dispatching task is set with the parameter information.

In the above embodiment, the power dispatching task may be a computing task for dispatching power output or power stock in scenarios such as power production and power sales. The power dispatching task may be set with multiple parameter information (such as processing mode information, processing time limit information, task type information, and the like).

In the above embodiment, before the corresponding processing mode of the power dispatching task is determined based on the problem structure information of the power dispatching problem, it is necessary to determine whether the power dispatching task is set with the parameter information corresponding to the remote processing mode. If the power dispatching task is set with the parameter information corresponding to the remote processing mode, the processing mode of the power dispatching task may be set to the local processing mode, the remote processing mode, or simultaneous use of the local processing mode and the remote processing mode according to the problem structure information. If the power dispatching task is not set with the parameter information corresponding to the remote processing mode, the processing mode of the power dispatching task may be set to the local processing mode.

In some embodiments, the method for processing a computing task further includes the following steps S520 and S522.

At step S520, a solver corresponding to the processing mode and an optimization parameter corresponding to the solver are determined, where the optimization parameter is used for controlling the behavior of the solver.

At step S522, the optimization parameter is used for controlling the solver to acquire the power dispatching result.

In the above embodiment, for the processing mode of the power dispatching task, the solver corresponding to the processing mode and the optimization parameter corresponding to the solver can be determined. The optimization parameter can be used for controlling the solver to acquire the power dispatching result of the power dispatching task.

For example, if it is determined that the processing mode of the power dispatching computing task Q22 is a local processing mode according to the problem structure information of a power dispatching computing task Q22, a solver S22 for local processing, corresponding to the power dispatching computing task Q22, can be determined, and an optimization parameter C22 corresponding to the solver S22 can be determined. Then, the optimization parameter C22 can be used on a local device to control the solver S22 to acquire a power dispatching result R22 of the power dispatching computing task Q22.

For another example, if it is determined that the processing mode of the power dispatching computing task Q23 is a remote processing mode according to the problem structure information of a power dispatching computing task Q23, a solver S23 for remote processing, corresponding to the power dispatching computing task Q23, can be determined, and an optimization parameter C23 corresponding to the solver can be determined. Then, the optimization parameter C23 can be used on a remote server to control the solver S23 to acquire a power dispatching result R23 of the power dispatching computing task Q23

Through the method provided in this embodiment, the API for local solving and the API for remote solving can be unified, then, the amount of computing resources to be used is acquired by identifying the power dispatching task, and the local processing mode, the remote processing mode or the simultaneous local and remote processing mode is automatically determined based on the amount of computing resources to be used, thereby avoiding the problem that the user needs to perform manual selection when processing the computing task.

In some embodiments, a graphical user interface is provided by a terminal device, the content displayed in the graphical user interface at least partially includes a power dispatching scenario, and the method for processing a computing task further includes the following steps S524 to S530.

At step S524, a plurality of candidate power dispatching models are displayed in the graphical user interface.

At step S526, a target power dispatching model is determined from the plurality of candidate power dispatching models in response to a first control operation acting on the graphical user interface.

At step S528, a power dispatching parameter associated with the target power dispatching model is set in response to a second control operation acting on the target power dispatching model.

At step S530, the power dispatching result is acquired based on the target power dispatching model and the power dispatching parameter in response to a third control operation acting on a target control, and the power dispatching result is displayed in the graphical user interface.

In the above embodiment, a user can at least partially obtain the above power dispatching scenario through the content in the graphical user interface displayed through an electronic apparatus. The user can perform the first control operation, the second control operation, and the third control operation in the power dispatching scenario. A plurality of candidate power dispatching models can be displayed in the above graphical user interface.

Specifically, in the above graphical user interface, the user can perform the first control operation on the graphical user interface, that is, the user can determine the target power dispatching model by controlling part of the plurality of candidate power dispatching models displayed in the graphical user interface.

Specifically, in the above graphical user interface, the user can perform the second control operation on the target power dispatching model, that is, the user can set the above power dispatching parameter of the target power dispatching model by controlling control buttons (such as a setting button, an association button, and the like) corresponding to the target power dispatching model. The power dispatching parameter can be used for controlling the solver to acquire the power dispatching result of the power dispatching task.

Specifically, in the above graphical user interface, the user can perform the third control operation on the target control, that is, the user can acquire the above power dispatching result based on the above target power dispatching model and the above power dispatching parameter by controlling trigger buttons (such as a computation starting button, a result acquiring button, and the like) corresponding to the computing process, and the power dispatching result is displayed to the user through the graphical user interface.

In particular, the first control operation, the second control operation, and the third control operation may be touch control operations. The touch control operation refers to the user touching the display screen of the above terminal device with a finger and controlling the terminal device. The touch control operation may include single-point touch or multi-point touch, where the touch control operation of each touch point may include clicking, long-pressing, re-pressing, swiping, or the like. The above first control operation, the above second control operation and the above third control operation may also be control operations implemented through input devices such as a mouse and a keyboard.

In some embodiments, the method for processing a computing task further includes the following steps S532 and S534.

At step S532, the parameter content of the power dispatching parameter is adjusted in response to a fourth control operation acting on the power dispatching parameter to obtain an adjusted result.

At step S534, the power dispatching result is updated based on the adjusted result.

In the above embodiment, the user can also perform the fourth control operation on the power dispatching parameter in the graphical user interface, that is, the user can adjust the parameter content of the power dispatching parameter by controlling controls (such as an adjusting button, an adjusting control bar, and the like) related to the parameter content of the power dispatching parameter, thereby obtaining the adjusted result. The adjusted result can be used for updating the power dispatching result.

In particular, the fourth control operation may be a touch operation. The touch operation refers to the user touching the display screen of the above terminal device with a finger and controlling the terminal device. The touch operation may include single-point touch or multi-point touch, where the touch operation of each touch point may include clicking, long-pressing, re-pressing, swiping, or the like. The above fourth control operation may also be a control operation implemented through input devices such as a mouse and a keyboard.

It is to be noted that for the above method embodiments, for the sake of simple description, they are expressed as a series of action combinations. However, those skilled in the art should know that the present disclosure is not limited by an order of described actions. According to the present disclosure, some steps may be performed in other orders or simultaneously. Secondly, those skilled in the art should also know that the embodiments described in the specification belong to preferred embodiments, and the actions and modules involved are not necessarily required by the present disclosure.

Through the description of the above implementations, those skilled in the art can clearly know that the method according to the above embodiments can be implemented by means of software and a necessary universal hardware platform, and the method can also be implemented through hardware. Based on such an understanding, the technical solutions of the present disclosure essentially, or the part contributing to the prior art, may be presented in the form of a software product. The computer software product is stored in a storage medium (such as a ROM/RAM, a magnetic disk, or an optical disk), and includes several instructions for instructing a terminal device (which may be a mobile phone, a computer, a server, a network device, or the like) to execute the methods described in the embodiments of the present disclosure.

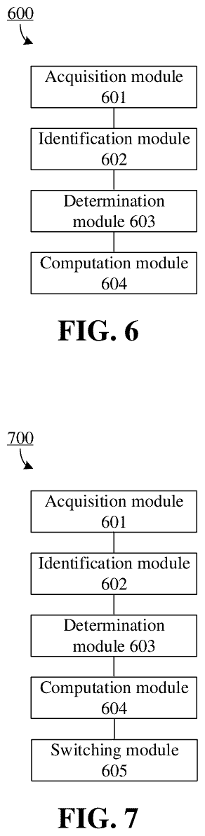

According to some embodiments of the present disclosure, an apparatus for implementing the above method for processing a computing task is also provided. FIG. 6 is a schematic structural diagram of an exemplary apparatus 600 for processing a computing task, according to some embodiments of the present disclosure. As shown in FIG. 6, the apparatus 600 includes: an acquisition module 601, an identification module 602, a determination module 603 and a computation module 604.

The acquisition module 601 includes circuitry configured to acquire a target computing task, where the target computing task is used for solving a target problem. The identification module 602 includes circuitry configured to identify the target computing task and determine problem structure information of the target problem. The determination module 603 includes circuitry configured to determine a processing mode of the target computing task based on the problem structure information. The computation module 604 includes circuitry configured to acquire a computed result of the target computing task according to the processing mode.

In some embodiments, the identification module 602 further includes circuitry configured to: identify the target computing task, and determine a target optimization model corresponding to the target computing task, where the target optimization model is used for modeling the target computing task into a target form to be solved; acquire feature information of the target optimization model, where the feature information is used for representing the computing content corresponding to the target computing task; and determine the problem structure information based on the feature information.

In some embodiments, the determination module 603 further includes circuitry configured to: determine the amount of computing resources of the target computing task based on the problem structure information; determine that the processing mode of the target computing task is a local processing mode when the amount of computing resources meets a first preset condition; determine that the processing mode of the target computing task is a remote processing mode when the amount of computing resources meets a second preset condition; and determine that the processing mode of the target computing task is simultaneous use of the local processing mode and the remote processing mode when the amount of computing resources meets a third preset condition.

In some embodiments, FIG. 7 is a schematic structural diagram of another apparatus 700 for processing a computing task, according to some embodiments of the present disclosure. As shown in FIG. 7, in addition to all modules shown in FIG. 6, the apparatus 700 further includes: a switching module 605. The switching module 605 includes circuitry configured to acquire the current network connection status information, where the network connection status information is used for determining whether the current network connection is abnormal; and switch between multiple processing modes based on the network connection status information, where the multiple processing modes include: the local processing mode, the remote processing mode, and simultaneous use of the local processing mode and the remote processing mode.

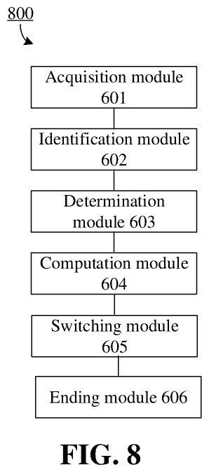

In some embodiments, FIG. 8 is a schematic structural diagram of still another apparatus 800 for processing a computing task, according to some embodiments of the present disclosure. As shown in FIG. 8, in addition to all modules shown in FIG. 7, the apparatus 800 further includes: an ending module 606. The ending module 606 includes circuitry configured to, when the local processing mode and the remote processing mode are simultaneously used and the computed result is acquired in any one of the local processing mode and the remote processing mode, end the other one of the local processing mode and the remote processing mode.

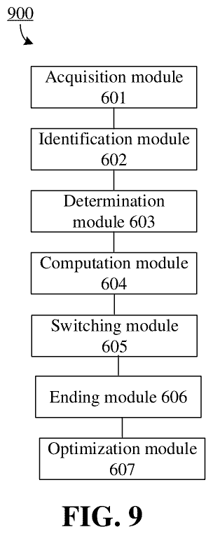

In some embodiments, FIG. 9 is a schematic structural diagram of yet another apparatus 900 for processing a computing task, according to some embodiment of the present disclosure. As shown in FIG. 9, in addition to all modules shown in FIG. 8, the apparatus 900 further includes: an optimization module 607. The optimization module 607 includes circuitry configured to determine a solver corresponding to the processing mode and an optimization parameter corresponding to the solver, where the optimization parameter is used for controlling the behavior of the solver; and use the optimization parameter to control the solver to acquire the computed result.

It is to be noted that the acquisition module 601, identification module 602, determination module 603 and computation module 604 correspond to step S202 to step S208. The examples and application scenarios implemented by the four modules and corresponding steps are the same, but are not limited to the content disclosed in the present disclosure. It is to be noted that the above modules serving as part of the apparatus can run in the computer terminal 10.

In this embodiment of the present disclosure, first, a target computing task is acquired by the acquisition module, where the target computing task is used for solving a target problem; the target computing task is identified by the identification module, and problem structure information of the target problem is determined; then, a method of determining a processing mode of the target computing task based on the problem structure information by the determination module is used; and thus, a computed result of the target computing task is acquired according to the processing mode by the computation module.

It is easy to notice that through this embodiment of the present disclosure, the target computing task is identified and the problem structure information of the target problem is acquired, thereby determining the processing mode of the target computing task. The processing mode may be local solving, remote solving, or simultaneous solving. As a result, the purpose of enabling the solver to automatically select a processing mode according to the problem structure information of the target problem is achieved to realize the technical effects of integrating the advantages of local solving and remote solving and improving the flexibility of the solving process of the solver, thereby solving the technical problem in the prior art that a method of fixing a processing mode of a solver to local solving or remote solving is poor in flexibility of a solving process.

It is to be noted that for the preferred implementation of this embodiment, reference can be made to the relevant description method embodiments, which will not be described again here.

According to some embodiments of the present disclosure, an electronic apparatus is also provided. The electronic apparatus may be any computing device in a computing device group. The electronic apparatus includes: a processor and a memory.

The memory is communicatively coupled to the processor and configured to provide instructions for the above processor to process the following processing steps: a target computing task is acquired, where the target computing task is used for solving a target problem; the target computing task is identified to determine problem structure information of the target problem; a processing mode of the target computing task is determined based on the problem structure information; and a computed result of the target computing task is acquired according to the processing mode.

In this embodiment of the present disclosure, first, a target computing task is acquired, where the target computing task is used for solving a target problem; problem structure information of the target problem is determined by identifying the target computing task; a method of determining a processing mode of the target computing task based on the problem structure information is used; and a computed result of the target computing task is acquired according to the processing mode.

It is easy to notice that through this embodiment of the present disclosure, the target computing task is identified, and the problem structure information of the target problem is acquired, thereby determining the processing mode of the target computing task. The processing mode may be local solving, remote solving, or simultaneous solving. As a result, the purpose of enabling the solver to automatically select a processing mode according to the problem structure information of the target problem is achieved to realize the technical effects of integrating the advantages of local solving and remote solving and improving the flexibility of the solving process of the solver, thereby solving the technical problem in the prior art that a method of fixing a processing mode of a solver to local solving or remote solving is poor in flexibility of a solving process.

It is to be noted that for the preferred implementation of this embodiment, reference can be made to the relevant description in method embodiments, which will not be described again here.

Some embodiments of the present disclosure may provide a computer terminal. The computer terminal may be any computer terminal device in a computer terminal group. In some embodiments, the above computer terminal may also be replaced with a terminal device such as a mobile terminal.

In some embodiments, the above computer terminal may be located in at least one of a plurality of network devices in a computer network.

In this embodiment, the above computer terminal can execute program codes of the following steps in the method for processing a computing task: a target computing task is acquired; the target computing task is identified to determine problem structure information of a target problem; a processing mode of the target computing task is determined based on the amount of computing resources; and a computed result of the target computing task is acquired according to the processing mode.

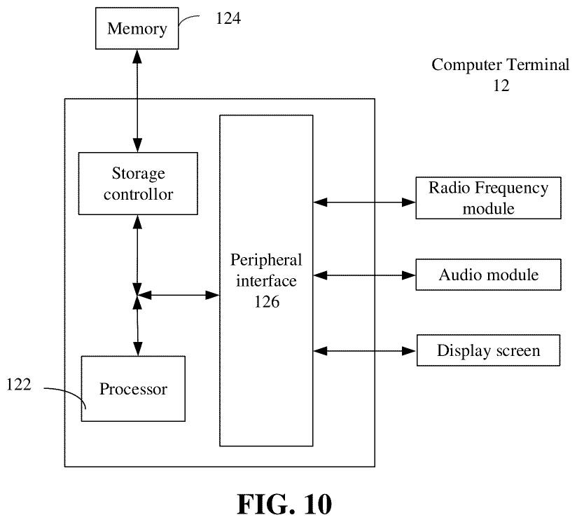

In some embodiments, FIG. 10 is a structural block diagram of another computer terminal 12, according to some embodiments of the present disclosure. As shown in FIG. 10, the computer terminal 12 may include: one or a plurality of processors 122 (only one processor 122 is shown in the figure), a memory 124, and a peripheral interface 126.

The memory 124 can be configured to store software programs and modules, such as program instructions/modules corresponding to the method and apparatus for processing a computing task in this embodiment of the present disclosure. The processor 122 executes various functional applications and data processing by running the software programs and modules stored in the memory, thereby implementing the above method for processing a computing task. The memory 124 may include a high-speed random access memory, and may also include a non-volatile memory, such as one or a plurality of magnetic storage apparatuses, a flash memory, or another non-volatile solid-state memory. In some examples, the memory 124 may further include memories remotely arranged relative to the processor 122, and the remote memories may be connected to the computer terminal through a network. The examples of the above network include but are not limited to the Internet, Intranet, local area networks, mobile communication networks, and combinations thereof.

The processor can call the information and application programs stored in the memory through the transmission apparatus to execute the following steps: a target computing task is acquired, where the target computing task is used for solving a target problem; the target computing task is identified to determine problem structure information of the target problem; a processing mode of the target computing task is determined based on the problem structure information; and a computed result of the target computing task is acquired according to the processing mode.

In some embodiments, the processor 122 can also execute program codes of the following steps: the target computing task is identified to determine a target optimization model corresponding to the target computing task, where the target optimization model is used for modeling the target computing task into a target form to be solved; feature information of the target optimization model is acquired, where the feature information is used for representing the computing content corresponding to the target computing task; and the problem structure information is determined based on the feature information.

In some embodiments, the processor 122 can also execute program codes of the following steps: the amount of computing resources of the target computing task is determined based on the problem structure information; it is determined that the processing mode of the target computing task is a local processing mode when the amount of computing resources meets a first preset condition; it is determined that the processing mode of the target computing task is a remote processing mode when the amount of computing resources meets a second preset condition; and it is determined that the processing mode of the target computing task is simultaneous use of the local processing mode and the remote processing mode when the amount of computing resources meets a third preset condition.

In some embodiments, the processor 122 can also execute program codes of the following steps: the current network connection status information is acquired, where the network connection status information is used for determining whether the current network connection is abnormal; and switching is performed between multiple processing modes based on the network connection status information, where the multiple processing modes include: the local processing mode, the remote processing mode, and simultaneous use of the local processing mode and the remote processing mode.

In some embodiments, the processor 122 can also execute program codes of the following step: when the local processing mode and the remote processing mode are simultaneously used and the computed result is acquired in any one of the local processing mode and the remote processing mode, the other one of the local processing mode and the remote processing mode is ended.

In some embodiments, the processor 122 can also execute program codes of the following steps: a solver corresponding to the processing mode and an optimization parameter corresponding to the solver are determined, where the optimization parameter is used for controlling the behavior of the solver; and the optimization parameter is used for controlling the solver to acquire the computed result.

In some embodiments, the processor 122 can also execute program codes of the following steps: a plurality of candidate optimization models are displayed in a graphical user interface; a target optimization model is determined from the plurality of candidate optimization models in response to a first control operation acting on the graphical user interface; an optimization parameter associated with the target optimization model is set in response to a second control operation acting on the target optimization model; and the computed result is acquired based on the target optimization model and the optimization parameter in response to a third control operation acting on a target control, and the computed result is displayed in the graphical user interface.

In some embodiments, the processor 122 can also execute program codes of the following steps: the parameter content of the optimization parameter is adjusted in response to a fourth control operation acting on the optimization parameter to obtain an adjusted result; and the computed result is updated based on the adjusted result.

The processor 123 can call the information and application programs stored in the memory 124 through the transmission apparatus to execute the following steps: an e-commerce traffic allocation task is acquired, where the e-commerce traffic allocation task is used for solving an e-commerce traffic allocation problem; the e-commerce traffic allocation task is identified to determine problem structure information of the e-commerce traffic allocation problem; a processing mode of the e-commerce traffic allocation task is determined based on the problem structure information; and an e-commerce traffic allocation result of the e-commerce traffic allocation task is acquired according to the processing mode.

In some embodiments, the processor 122 can also execute program codes of the following steps: a plurality of candidate e-commerce traffic allocation models are displayed in a graphical user interface; a target e-commerce traffic allocation model is determined from the plurality of candidate e-commerce traffic allocation models in response to a first control operation acting on the graphical user interface; an e-commerce traffic allocation parameter associated with the target e-commerce traffic allocation model is set in response to a second control operation acting on the target e-commerce traffic allocation model; and the e-commerce traffic allocation result is acquired based on the target e-commerce traffic allocation model and the e-commerce traffic allocation parameter in response to a third control operation acting on a target control, and the e-commerce traffic allocation result is displayed in the graphical user interface.

The processor 122 can call the information and application programs stored in the memory 124 through the transmission apparatus to execute the following steps: a power dispatching task is acquired, where the power dispatching task is used for solving a power dispatching problem; the power dispatching task is identified to determine problem structure information of the power dispatching problem; a processing mode of the power dispatching task is determined based on the problem structure information; and a power dispatching result of the power dispatching task is acquired according to the processing mode.

In this embodiment of the present disclosure, first, a target computing task is acquired, where the target computing task is used for solving a target problem; problem structure information of the target problem is determined by identifying the target computing task; a method of determining a processing mode of the target computing task based on the problem structure information is used; and a computed result of the target computing task is acquired according to the processing mode.

It is easy to notice that through this embodiment of the present disclosure, the target computing task is identified, and the problem structure information of the target problem is acquired, thereby determining the processing mode of the target computing task. The processing mode may be local solving, remote solving or simultaneous solving. As a result, the purpose of enabling the solver to automatically select a processing mode according to the problem structure information of the target problem is achieved to realize the technical effects of integrating the advantages of local solving and remote solving and improving the flexibility of the solving process of the solver, thereby solving the technical problem in the prior art that a method of fixing a processing mode of a solver to local solving or remote solving is poor in flexibility of a

Those of ordinary skill in the art can understand that the structure shown in FIG. 10 is only schematic. The computer terminal 12 may also be a terminal device such as a smart phone (such as an Android mobile phone or an iOS mobile phone), a tablet computer, a palmtop computer, a mobile Internet device (MID), or a PAD. FIG. 10 does not limit the structure of the above electronic apparatus. For example, the computer terminal 12 may further include more or less components (such as a network interface and a display apparatus) than those shown in FIG. 10, or has configurations different from those shown in FIG. 10.

Those of ordinary skill in the art can understand that all or part of the steps in the various methods of the above embodiments may be completed by instructing the hardware related to the terminal device through a program. The program may be stored in a computer-readable storage medium, and the storage medium may include: a flash disk, a read-only memory (ROM), a random access memory (RAM), a magnetic disk or an optical disk, and the like.

According to some embodiments of the present disclosure, a non-transitory computer-readable storage medium is also provided. In some embodiments, the above computer-readable storage medium may be configured to store the program codes executed by the method for processing a computing task provided in method embodiments.

In some embodiments, the non-transitory computer-readable storage medium may be located in any computer terminal in a computer terminal group in a computer network or located in any mobile terminal in a mobile terminal group.

In some embodiments, the non-transitory computer-readable storage medium is configured to store program codes for executing the following steps: a target computing task is acquired, where the target computing task is used for solving a target problem; the target computing task is identified to determine problem structure information of the target problem; a processing mode of the target computing task is determined based on the problem structure information; and a computed result of the target computing task is acquired according to the processing mode.

In some embodiments, the non-transitory computer-readable storage medium is configured to store program codes for executing the following steps: the target computing task is identified to determine a target optimization model corresponding to the target computing task, where the target optimization model is used for modeling the target computing task into a target form to be solved; feature information of the target optimization model is acquired, where the feature information is used for representing the computing content corresponding to the target computing task; and the problem structure information is determined based on the feature information.

In some embodiments, the non-transitory computer-readable storage medium is configured to store program codes for executing the following steps: the amount of computing resources of the target computing task is determined based on the problem structure information; it is determined that the processing mode of the target computing task is a local processing mode when the amount of computing resources meets a first preset condition; it is determined that the processing mode of the target computing task is a remote processing mode when the amount of computing resources meets a second preset condition; and it is determined that the processing mode of the target computing task is simultaneous use of the local processing mode and the remote processing mode when the amount of computing resources meets a third preset condition.

In some embodiments, the non-transitory computer-readable storage medium is configured to store program codes for executing the following steps: the current network connection status information is acquired, where the network connection status information is used for determining whether the current network connection is abnormal; and switching is performed between multiple processing modes based on the network connection status information, where the multiple processing modes include: the local processing mode, the remote processing mode, and simultaneous use of the local processing mode and the remote processing mode.

In some embodiments, the non-transitory computer-readable storage medium is configured to store program codes for executing the following step: when the local processing mode and the remote processing mode are simultaneously used and the computed result is acquired in any one of the local processing mode and the remote processing mode, the other one of the local processing mode and the remote processing mode is ended.

In some embodiments, the non-transitory computer-readable storage medium is configured to store program codes for executing the following steps: a solver corresponding to the processing mode and an optimization parameter corresponding to the solver are determined, where the optimization parameter is used for controlling the behavior of the solver; and the optimization parameter is used for controlling the solver to acquire the computed result.

In some embodiments, the non-transitory computer-readable storage medium is configured to store program codes for executing the following steps: a plurality of candidate optimization models are displayed in a graphical user interface; a target optimization model is determined from the plurality of candidate optimization models in response to a first control operation acting on the graphical user interface; an optimization parameter associated with the target optimization model is set in response to a second control operation acting on the target optimization model; and the computed result is acquired based on the target optimization model and the optimization parameter in response to a third control operation acting on a target control, and the computed result is displayed in the graphical user interface.

In some embodiments, the non-transitory computer-readable storage medium is configured to store program codes for executing the following steps: the parameter content of the optimization parameter is adjusted in response to a fourth control operation acting on the optimization parameter to obtain an adjusted result; and the computed result is updated based on the adjusted result.

In some embodiments, the non-transitory computer-readable storage medium is configured to store program codes for executing the following steps: an e-commerce traffic allocation task is acquired, where the e-commerce traffic allocation task is used for solving an e-commerce traffic allocation problem; the e-commerce traffic allocation task is identified to determine problem structure information of the e-commerce traffic allocation problem; a processing mode of the e-commerce traffic allocation task is determined based on the problem structure information; and an e-commerce traffic allocation result of the e-commerce traffic allocation task is acquired according to the processing mode.

In some embodiments, the non-transitory computer-readable storage medium is configured to store program codes for executing the following steps: a plurality of candidate e-commerce traffic allocation models are displayed in a graphical user interface; a target e-commerce traffic allocation model is determined from the plurality of candidate e-commerce traffic allocation models in response to a first control operation acting on the graphical user interface; an e-commerce traffic allocation parameter associated with the target e-commerce traffic allocation model is set in response to a second control operation acting on the target e-commerce traffic allocation model; and the e-commerce traffic allocation result is acquired based on the target e-commerce traffic allocation model and the e-commerce traffic allocation parameter in response to a third control operation acting on a target control, and the e-commerce traffic allocation result is displayed in the graphical user interface.

In some embodiments, the non-transitory computer-readable storage medium is configured to store program codes for executing the following steps: a power dispatching task is acquired, where the power dispatching task is used for solving a power dispatching problem; the power dispatching task is identified to determine problem structure information of the power dispatching problem; a processing mode of the power dispatching task is determined based on the problem structure information; and a power dispatching result of the power dispatching task is acquired according to the processing mode.

The embodiments may further be described using the following clauses:

1. A method for processing a computing task, comprising:
acquiring a target computing task used for solving a target problem;
identifying the target computing task to determine problem structure information of the target problem;
determining a processing mode of the target computing task based on the problem structure information; and
acquiring a computed result of the target computing task according to the processing mode.

2. The method according to clause 1, wherein identifying the target computing task to determine the problem structure information of the target problem comprises:
identifying the target computing task to determine a target optimization model corresponding to the target computing task, wherein the target optimization model is used for modeling the target computing task into a target form to be solved;
acquiring feature information of the target optimization model, wherein the feature information is used for representing computing content corresponding to the target computing task; and determining the problem structure information based on the feature information.

3. The method according to clause 1, wherein determining the processing mode of the target computing task based on the problem structure information comprises:
determining an amount of computing resources of the target computing task based on the problem structure information;
determining the processing mode of the target computing task to be a local processing mode when the amount of computing resources meets a first preset condition;
determining the processing mode of the target computing task to be a remote processing mode when the amount of computing resources meets a second preset condition; and
determining the processing mode of the target computing task to be simultaneous use of the local processing mode and the remote processing mode when the amount of computing resources meets a third preset condition.

4. The method according to clause 3, further comprising:
acquiring a current network connection status information, wherein the current network connection status information is used for determining whether the current network connection is abnormal; and
switching between multiple processing modes based on the current network connection status information, wherein the multiple processing modes comprise:
the local processing mode,
the remote processing mode, and
simultaneous use of the local processing mode and the remote processing mode.

5. The method according to clause 3, further comprising:
when the local processing mode and the remote processing mode are simultaneously used and the computed result is acquired in any one of the local processing mode and the remote processing mode, ending the other one of the local processing mode and the remote processing mode.

6. The method according to clause 1, wherein acquiring the computed result of the target computing task according to the processing mode comprises:
determining a solver corresponding to the processing mode and an optimization parameter corresponding to the solver, wherein the optimization parameter is used for controlling a behavior of the solver; and
using the optimization parameter to control the solver to acquire the computed result.

7. The method according to clause 1, wherein a graphical user interface is provided by a terminal device, content displayed in the graphical user interface at least partially comprises a computing task solving scenario, and the method further comprises:
displaying a plurality of candidate optimization models in the graphical user interface;
determining a target optimization model from the plurality of candidate optimization models in response to a first control operation acting on the graphical user interface;
setting an optimization parameter associated with the target optimization model in response to a second control operation acting on the target optimization model;
acquiring the computed result based on the target optimization model and the optimization parameter in response to a third control operation acting on a target control; and
displaying the computed result in the graphical user interface.

8. The method according to clause 7, further comprising:
adjusting parameter content of the optimization parameter in response to a fourth control operation acting on the optimization parameter to obtain an adjusted result; and
updating the computed result based on the adjusted result.

9. A method for processing a computing task, comprising:
acquiring an e-commerce traffic allocation task, wherein the e-commerce traffic allocation task is used for solving an e-commerce traffic allocation problem;
identifying the e-commerce traffic allocation task to determine problem structure information of the e-commerce traffic allocation problem;
determining a processing mode of the e-commerce traffic allocation task based on the problem structure information; and
acquiring an e-commerce traffic allocation result of the e-commerce traffic allocation task according to the processing mode.

10. The method according to clause 9, wherein a graphical user interface is provided by a terminal device, content displayed in the graphical user interface at least partially comprises an e-commerce traffic allocation scenario, and the method further comprises:
displaying a plurality of candidate e-commerce traffic allocation models in the graphical user interface;
determining a target e-commerce traffic allocation model from the plurality of candidate e-commerce traffic allocation models in response to a first control operation acting on the graphical user interface;
setting an e-commerce traffic allocation parameter associated with the target e-commerce traffic allocation model in response to a second control operation acting on the target e-commerce traffic allocation model;
acquiring the e-commerce traffic allocation result based on the target e-commerce traffic allocation model and the e-commerce traffic allocation parameter in response to a third control operation acting on a target control; and displaying the e-commerce traffic allocation result in the graphical user interface.

11. A method for processing a computing task, comprising:
acquiring a power dispatching task, wherein the power dispatching task is used for solving a power dispatching problem;
identifying the power dispatching task, and determining problem structure information of the power dispatching problem;
determining a processing mode of the power dispatching task based on the problem structure information; and
acquiring a power dispatching result of the power dispatching task according to the processing mode.

12. A system for processing a computing task, comprising:
a processor, and
a memory coupled to the processor and configured to provide instructions for the processor to process operations comprising:
acquiring a target computing task, wherein the target computing task is used for solving a target problem;
identifying the target computing task, and determining problem structure information of the target problem;
determining a processing mode of the target computing task based on the problem structure information; and
acquiring a computed result of the target computing task according to the processing mode.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for processing a computing task, comprising:
acquiring a target computing task used for solving a target problem;
identifying the target computing task to determine problem structure information of the target problem;
determining a processing mode of the target computing task based on the problem structure information; and
acquiring a computed result of the target computing task according to the processing mode.

2. The method according to claim 1, wherein identifying the target computing task to determine the problem structure information of the target problem comprises:
identifying the target computing task to determine a target optimization model corresponding to the target computing task, wherein the target optimization model is used for modeling the target computing task into a target form to be solved;
acquiring feature information of the target optimization model, wherein the feature information is used for representing computing content corresponding to the target computing task; and
determining the problem structure information based on the feature information.

3. The method according to claim 1, wherein determining the processing mode of the target computing task based on the problem structure information comprises:
determining an amount of computing resources of the target computing task based on the problem structure information; and
determining the processing mode of the target computing task to be:
a local processing mode when the amount of computing resources meets a first preset condition;
a remote processing mode when the amount of computing resources meets a second preset condition; or
a simultaneous use of the local processing mode and the remote processing mode when the amount of computing resources meets a third preset condition.

4. The method according to claim 3, further comprising:
acquiring a current network connection status information, wherein the current network connection status information is used for determining whether the current network connection is abnormal; and
switching between multiple processing modes based on the current network connection status information, wherein the multiple processing modes comprise:
the local processing mode,
the remote processing mode, and
simultaneous use of the local processing mode and the remote processing mode.

5. The method according to claim 3, further comprising:
when the local processing mode and the remote processing mode are simultaneously used and the computed result is acquired in any one of the local processing mode and the remote processing mode, ending the other one of the local processing mode and the remote processing mode.

6. The method according to claim 1, wherein acquiring the computed result of the target computing task according to the processing mode comprises:
determining a solver corresponding to the processing mode and an optimization parameter corresponding to the solver, wherein the optimization parameter is used for controlling a behavior of the solver; and
using the optimization parameter to control the solver to acquire the computed result.

7. The method according to claim 1, wherein a graphical user interface is provided by a terminal device, content displayed in the graphical user interface at least partially comprises a computing task solving scenario, and the method further comprises:
displaying a plurality of candidate optimization models in the graphical user interface;
determining a target optimization model from the plurality of candidate optimization models in response to a first control operation acting on the graphical user interface;
setting an optimization parameter associated with the target optimization model in response to a second control operation acting on the target optimization model;
acquiring the computed result based on the target optimization model and the optimization parameter in response to a third control operation acting on a target control; and
displaying the computed result in the graphical user interface.

8. The method according to claim 7, further comprising:
adjusting parameter content of the optimization parameter in response to a fourth control operation acting on the optimization parameter to obtain an adjusted result; and
updating the computed result based on the adjusted result.

9. A system for processing a computing task, comprising:
a memory configured to store instructions; and
one or more processors configured to execute the instructions to cause the system to perform operations comprising:
acquiring a target computing task, wherein the target computing task is used for solving a target problem;
identifying the target computing task, and determining problem structure information of the target problem;
determining a processing mode of the target computing task based on the problem structure information; and
acquiring a computed result of the target computing task according to the processing mode.

10. The system according to claim 9, wherein identifying the target computing task to determine the problem structure information of the target problem comprises:
identifying the target computing task to determine a target optimization model corresponding to the target computing task, wherein the target optimization model is used for modeling the target computing task into a target form to be solved;
acquiring feature information of the target optimization model, wherein the feature information is used for representing computing content corresponding to the target computing task; and
determining the problem structure information based on the feature information.

11. The system according to claim 9, wherein determining the processing mode of the target computing task based on the problem structure information comprises:
determining an amount of computing resources of the target computing task based on the problem structure information;
determining the processing mode of the target computing task to be a local processing mode when the amount of computing resources meets a first preset condition;
determining the processing mode of the target computing task to be a remote processing mode when the amount of computing resources meets a second preset condition; and
determining the processing mode of the target computing task to be simultaneous use of the local processing mode and the remote processing mode when the amount of computing resources meets a third preset condition.

12. The system according to claim 11, the operations further comprise:
acquiring a current network connection status information, wherein the current network connection status information is used for determining whether the current network connection is abnormal; and
switching between multiple processing modes based on the current network connection status information, wherein the multiple processing modes comprise:
the local processing mode,
the remote processing mode, and
simultaneous use of the local processing mode and the remote processing mode.

13. The system according to claim 11, the operations further comprise:
when the local processing mode and the remote processing mode are simultaneously used and the computed result is acquired in any one of the local processing mode and the remote processing mode, ending the other one of the local processing mode and the remote processing mode.

14. The system according to claim 9, wherein acquiring the computed result of the target computing task according to the processing mode comprises:
determining a solver corresponding to the processing mode and an optimization parameter corresponding to the solver, wherein the optimization parameter is used for controlling a behavior of the solver; and
using the optimization parameter to control the solver to acquire the computed result.

15. The system according to claim 9, wherein a graphical user interface is provided by a terminal device, content displayed in the graphical user interface at least partially comprises a computing task solving scenario, and the operations further comprise:
displaying a plurality of candidate optimization models in the graphical user interface;
determining a target optimization model from the plurality of candidate optimization models in response to a first control operation acting on the graphical user interface;
setting an optimization parameter associated with the target optimization model in response to a second control operation acting on the target optimization model;
acquiring the computed result based on the target optimization model and the optimization parameter in response to a third control operation acting on a target control; and
displaying the computed result in the graphical user interface.

16. The system according to claim 15, the operations further comprise:
adjusting parameter content of the optimization parameter in response to a fourth control operation acting on the optimization parameter to obtain an adjusted result; and
updating the computed result based on the adjusted result.

17. A non-transitory computer readable medium that stores a set of instructions that is executable by one or more processors of an apparatus to cause the apparatus to perform operations comprising:
acquiring a target computing task, wherein the target computing task is used for solving a target problem;
identifying the target computing task, and determining problem structure information of the target problem;
determining a processing mode of the target computing task based on the problem structure information; and
acquiring a computed result of the target computing task according to the processing mode.

18. The non-transitory computer readable medium according to claim 17, wherein identifying the target computing task to determine the problem structure information of the target problem comprises:
identifying the target computing task to determine a target optimization model corresponding to the target computing task, wherein the target optimization model is used for modeling the target computing task into a target form to be solved;
acquiring feature information of the target optimization model, wherein the feature information is used for representing computing content corresponding to the target computing task; and
determining the problem structure information based on the feature information.

19. The non-transitory computer readable medium according to claim 17, wherein determining the processing mode of the target computing task based on the problem structure information comprises:
determining an amount of computing resources of the target computing task based on the problem structure information;
determining the processing mode of the target computing task to be a local processing mode when the amount of computing resources meets a first preset condition;
determining the processing mode of the target computing task to be a remote processing mode when the amount of computing resources meets a second preset condition; and
determining the processing mode of the target computing task to be simultaneous use of the local processing mode and the remote processing mode when the amount of computing resources meets a third preset condition.

20. The non-transitory computer readable medium according to claim 17, wherein acquiring the computed result of the target computing task according to the processing mode comprises:
determining a solver corresponding to the processing mode and an optimization parameter corresponding to the solver, wherein the optimization parameter is used for controlling a behavior of the solver; and
using the optimization parameter to control the solver to acquire the computed result.
